(19) United States
(12) Patent Application Publication
(10) Pub. No.: US 2005/0069259 A1
(43) Pub. Date: Mar. 31, 2005

(54) Optical mode adapter provided with two separate channels

(76) Inventors: Stephane Tisserand, Marselle (FR); Boux Laurent, Marselle (FR); Fasieu Neversat, Narseille (FR); Jacob Sophie, Rousset (FR); Ludovic Escoubas, Marseille (FR); Emmanuel Drouard, Marselle (FR)

Correspondence Address: Horst M Kasper, 13 Forest Drive, Warren, NJ, 07059, US

(21) Appl. No.: 10/506,864

(22) PCT Filed: Feb. 28, 2003
(86) PCT No.: PCT/FR03/00646

(30) Foreign Application Priority Data
Mar. 1, 2002 (FR) 0202588

(51) Int. Cl. G02B 6/26

(52) U.S. Cl. 385/50; 385/28

(57) ABSTRACT

The invention concerns an optical mode adapter comprising first (C1) and second (C2) channels on an optical substrate (31) designed for connection of first and second waveguides respectively to its first (11) and to its second (12) ends. Said two channels being covered with at least a guide layer (33), the refractive index of the first channel (C1) is lower than that of the second channel (C2). The invention also concerns a method for making said adapter.

The present invention relates to an optical mode adapter provided with two separate channels.

The field of the invention is that of the integrated optics, field in which an aim is to implement a plurality of modules on the same substrate. A main element of these devices is the waveguide which delivers the light energy between the different modules.

A constant concern being to limit to the maximum the size of an integrated device, the waveguide shows dimensions as small as possible, and consequently supports a reduced propagation mode. Moreover, it's advisable to connect this device to any external equipment, what is generally done by means of an optical fiber. However, the optical fiber is a waveguide which supports an extended propagation mode of which the spatial extension is well higher than that of the reduced mode adopted in the integrated device.

It turns out that the connection between two guides of different geometry induces consequent optical losses

The aim of the present invention is therefore an optical mode adapter showing limited losses.

According to the invention, the adapter comprises first and second channels on an optical substrate, designed for the connection of first and second waveguides to its first and second ends, respectively, these two channels being covered with at least one guide layer, and the refractive index of the first channel is lower than that of the second channel.

Therefore, the index is adapted to the desired geomtrical characteristics of the separate propagation modes in the two channels.

Often, the width of the first channel is slightly higher than that of the second channel.

Preferably, the adapter comprises an adaptation cell in which the two channels are in contact, the first and second ends of this cell, respectively, being disposed near the first and second ends of the adapter, respectively, the width of the first channel decreasing from the first end to the second end of the adaptation cell. Furthermore, if possible, the width of the first channel is zero at the second end of such adaptation cell.

Likewise, the width of the second channel decreases from the second end to the first end of the adaptation cell, eventually becoming zero at the first end of this adaptation cell.

Eventually, the second end of the adaptation cell coincides with the second end of the adapter.

Moreover, the refractive index of the guide layer is higher than that of the substrate.

Advantageously, the adapter comprises at least one covering layer disposed on the guide layer, the index of such covering layer being lower than that of the guide layer and that of the channels.

According to a first embodiment of the adapter, at least one of these channels is integrated in the substrate.

According to a second embodiment of the adapter, at least one of these channels projects on the substrate.

Further, the index of the guide layer is equivalent to that of the substrate multiplied by a factor higher than 1,001.

Generally, the thickness of the whole of the guide layers is between 1 and 20 microns.

The aim of the invention is also for a first method for making an adapter, which includes the following steps:

implementation of a mask on the substrate to define the pattern of at least one of these channels,

ion implantation of the masked substrate,

withdrawal of the mask,

deposition of the guide layer on the substrate.

A second method includes the following steps:

ion implantation of the substrate,

implementation of a mask on the substrate to define the pattern of at least one of these channels,

etching of the substrate in a depth at least equal to the depth of implantation,

withdrawal of the mask,

deposition of the guide layer on the substrate.

Preferably, these two former methods include a step of annealing of the substrate which follows the ion implantation step.

A third method includes the following steps:

implementation of a mask on the substrate comprising moving ions to define the pattern of at least one of the channels,

dipping of the masked substrate in a bath comprising polarizable ions,

withdrawal of the mask,

deposition of the guide layer on the substrate.

A fourth method includes the following steps:

deposition of a first layer of higher refractive index than that of the substrate,

implementation of a first mask on this substrate to define the first channel,

etching of the substrate,

withdrawal of this first mask,

deposition of a second layer,

implementation of a second mask on this substrate to define the second channel,

etching of the substrate,

withdrawal of the second mask,

deposition of the guide layer on the substrate.

Further, these methods are adapted to the implementation of the different characteristics of the adapter above-mentioned.

Now, the present be better understood with more details by means of the following specifications of embodiment, by way of examples only, with reference to the accompanying drawings in which:

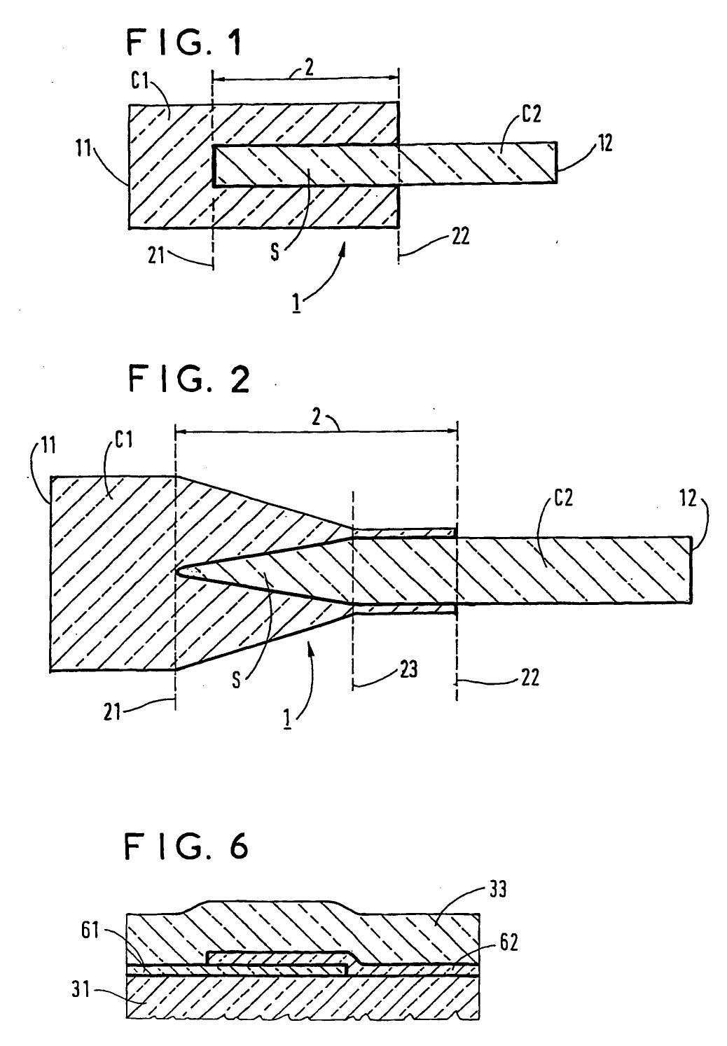

FIG. 1, is a plan view of the basic structure of an adapter,

FIG. 2, is a plan view of an improved adapter,

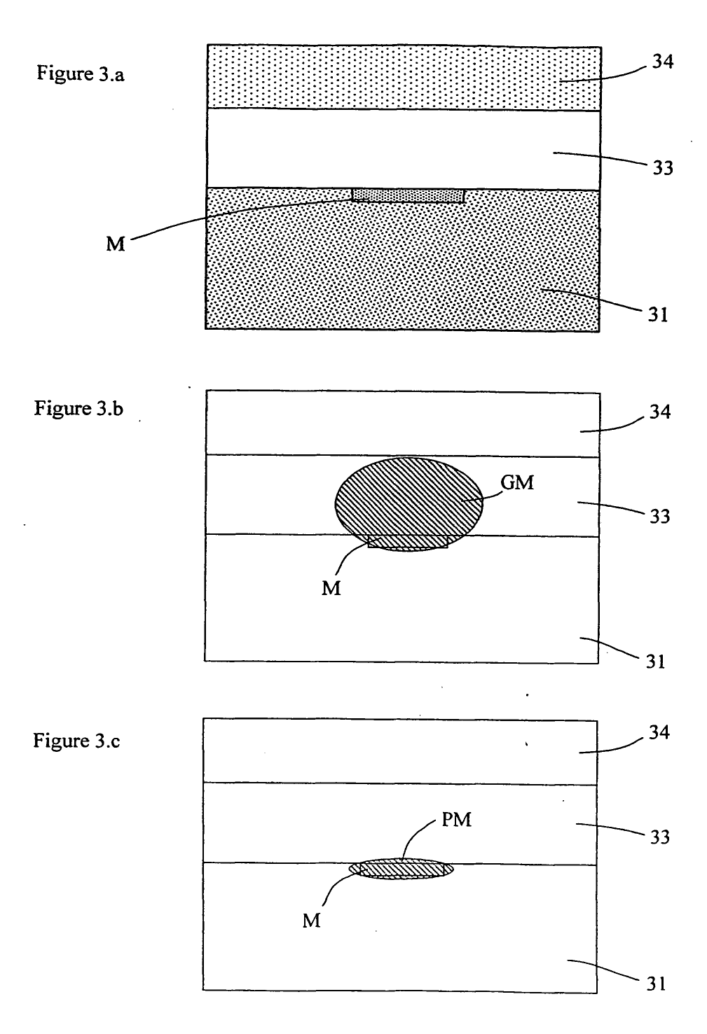

FIG. 3, is a cross-sectional view of an adapter,

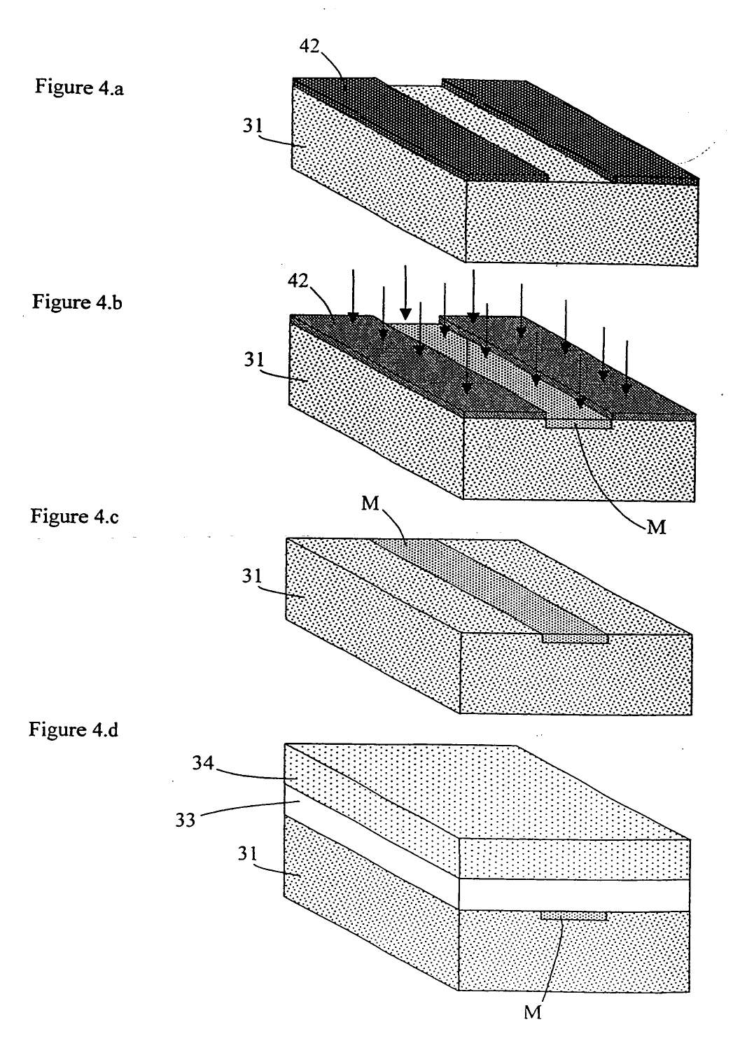

FIG. 4, shows the making of an adapter according to a first alternative,

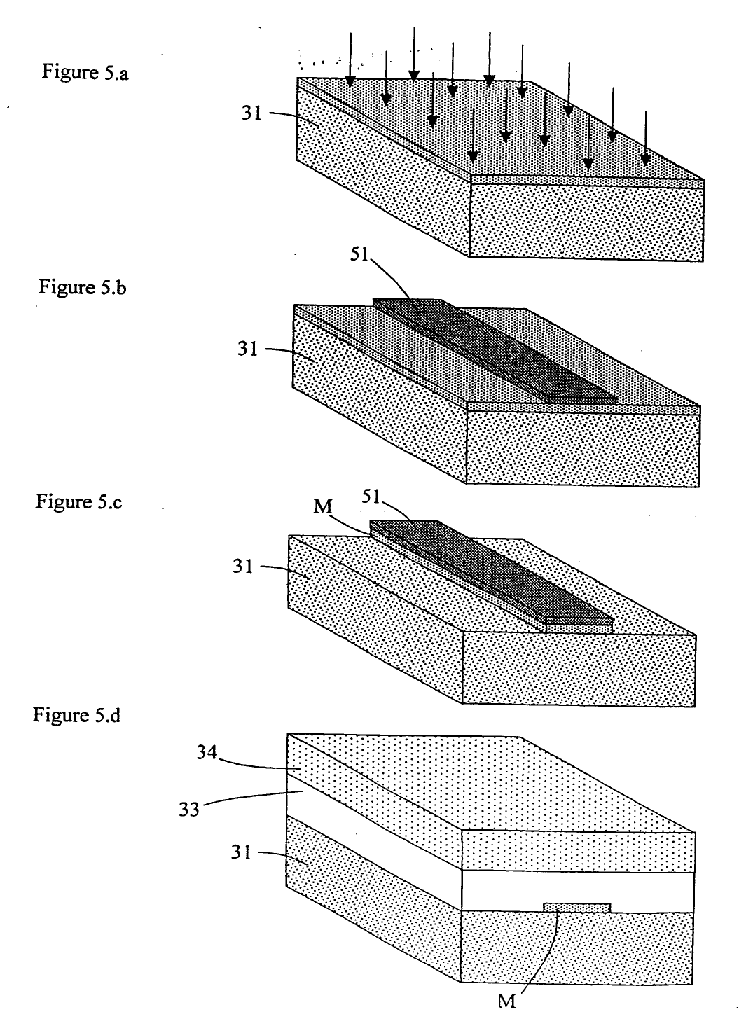

FIG. 5, shows the making of an adapter according to a second alternative, and

FIG. 6, is a cross-sectional view of an adapter implemented in thin layers.

The elements present in many drawings have the same reference throughout this specification.

Referring to FIG. 1, in its basic structure, the adapter 1 delimited by a first end 11 and a second end 12 comprises an adaptation cell 2 showing a first end 21 and a second end 22 set facing the corresponding ends of the adapter 1.

Eventually, the second end 22 of the adaptation cell is integrally with the second end 12 of the adapter.

A first channel C1 of rectangular shape extends according to a longitudinal axis from the first end 11 of the adapter to the second end 22 of the adaptation cell. A second channel C2 of smaller width than that of the first channel C1, equally of rectangular shape, extends according to the same longitudinal axis, from the second end 12 of the adapter to the first end 21 of the adaptation cell. The portion of the second channel C2 which is in the adaptation cell 2 infringes on the first channel C1, determining a coupling section S.

The refractive index of the first channel C1 is lower than that of the second channel C2.

The width of the second channel C2, which is here lower than that of the first channel C1, could eventually be equal to it, and even slightly higher.

Although the adaptation cell 2 isn't indispensable, it allows to sensibly reduce the coupling losses between the two channels.

Referring to FIG. 2, the structure of this cell can be optimised, and to explicit this, an alignment mark 23 is defined, which takes the shape of a line perpendicular to the axis of the adapter and disposed between the two ends 21 and 22 of the adaptation cell.

The width of the outer contour of the first channel C1 decreases from the first end 21 of this cell to the alignment mark 23. The decrease is here linear but it could be parabolic, exponential, or of any other type. This width is then sensibly constant between the alignment mark 23 and the second end 22 of the adaptation cell, slightly higher than the width of the second channel C2 outside this cell. The residual width of the first channel C1, which is equivalent to the width of its outer contour minus the width of the second channel C2, can even be cancelled.

The width of the second channel C2 is sensibly constant between the second end 22 of the adaptation cell and the alignment mark 23. It then decreases up to the first end 21 of the adaptation cell, being even able to be cancelled at this place.

Naturally, the adaptation cell 2 can take any shape, the important point being that the two channels C1 and C2 are in contact or almost in contact on at least one of their faces. Thus, the channels which are interleaved in FIG. 1 and FIG. 2 could alternatively be end-stacked, stacked or overlap each other to at least one common face.

According to a preferred embodiment, the adapter is implemented in using the ion implantation method.

Referring to FIG. 3a, the substrate is in silica, or it is in silicon on which, either we have grown thermal oxide, or we have deposited a layer of silicon dioxide or of another material. It presents therefore a top face or optical substrate 31, usually in silicon dioxide, with a thickness of 5 to 20 microns, for example. The first channel C1 implemented by ion implantation is here integrated to the optical substrate, which is itself covered with a guide layer 33. The refractive index of the channel is naturally higher than that of the silicon dioxide. The guide layer with a thickness of 5 microns, for example, is in doped silicon dioxide and shows a refractive index higher than that of the optical substrate, of 0.3% for example. It can eventually result from a stacking of thin layers. Preferably, a covering layer 34 which can also consist in a stacking of thin layers is planned on the guide layer 33. This covering layer, also with a thickness of 5 microns, has an index lower than that of the guide layer and that of the channel; in this present case, it is in non-doped silicon dioxide.

Referring to FIG. 4a, a first method for making the adapter comprises a first step which consists in implementing a first mask 42 on the optical substrate 31, this by means of a standard photolithographic process. This mask 42 is of resin, metal or all other material susceptible to constitute an insurmountable barrier for the ions during the implantation. Eventually, the mask can be obtained by a direct writing process. It reproduces an M-shaped pattern which corresponds to the connection of the two channels C1 and C2.

Referring to FIG. 4b, the M-shaped pattern is produced by ion implantation of the masked substrate. As an example, for a titanium implantation, the implantation dose D1 desired for the first channel C1 is comprised between 10¹⁶/cm² and 10¹⁸/cm², whereas the energy is comprised between some tens and some hundreds of KeV.

Referring to FIG. 4c, the first mask is withdrawn, for example by means of a chemical etching process.

The following step consists in implementing a second mask on the optical substrate 31 which reproduces the shape of the second channel C2. This second channel is produced by ion implantation of the masked substrate to a doze (D2−D1) comprised between 10¹⁶/cm² and 10¹⁸/cm², so that it presents a resulting implantation dose D2. Then, the mask is withdrawn again.

The positioning accuracy of the second mask with respect to the first mask being necessarily limited, the width of the first channel C1 between the alignment mark 23 and the second end 22 of the adaptation cell slightly exceeds the width of the second channel C2 outside this cell. Moreover, the width of the second channel C2 at the first end 21 of the adaptation cell isn't quite zero, because it is practically impossible to implement a perfect tip on a mask.

The substrate is then annealed to reduce the propagation losses within the two channels. As an example, the temperature is comprised between 400 and 500° C., the atmosphere is controlled or it concerns fres air, whereas the duration is in the order of some tens of hours.

Referring to FIG. 4d, the guide layer 33 is then deposited on the substrate 31 by means of any of the known methods provided that it leads to a material with slight losses of which the refractive index can be easily controlled. Finally, the covering layer 34 is eventually deposited on the guide layer 18.

Referring to FIG. 3b, the refractive index of the first channel C1 is relatively low, 1.56 for example, so that the extended propagation mode GM extends widely in the guide layer 33. The width of this channel, 7.5 microns for example, and the thickness of this guide layer are chosen so that the propagation mode GM is as close as possible to that of the single-mode optical fiber. We can then obtain a coupling coefficient to the fibers of 90%. The effective index of the guided mode is lower than the refractive index of the guide layer and than that of the channel; it is higher than the refractive index of the upper face 31 and than that of the covering layer 34.

Referring to FIG. 3c, the second channel C2 supports a reduced propagation mode PM, close to the one we find on the guides implanted without guide layer. It is then advisable that the channel index is relatively high, 1.90 for example. The width of this channel can sensibly be reduced. The effective index of the guided mode is here higher than that of the guide layer and lower than that of the channel. The lateral containment of the reduced mode PM is very important.

It can be noticed that now the ion implantation takes place with great accuracy on the doses of implanted ions, typically 1%. The optical substrate in silicon dioxide has a refractive index which presents none or few variations, so that a great accuracy on channel index can be achieved. As an example, for an implanted dose of titanium of 10¹⁶/cm² and 10¹⁷/cm², respectively, the accuracy on the refractive index reaches 10⁻⁴ and 10⁻³, respectively. This accuracy is particularly important when we're looking for the extended propagation mode GM, because the index of the first channel is a parameter which affects in a very sensitive manner the coupling to the optical fibers.

Referring to FIG. 5a, a second method for making the adapter comprises a first step which consists in implanting the totality of the optical substrate 31. The dose D1 and the implantation energy correspond to the ones anticipated for the first channel C1.

The following step consists in implementing a mask identical to the second mask of the above-mentioned method on the optical substrate 31. This second channel is then implanted to the dose (D2−D1), and the mask is withdrawn.

Referring to FIG. 5b, the next step consists in implementing a new mask 51 on the substrate 31. This mask defines a pattern complementary to that of the first mask used during the first method, but it must not be subject to the implantation step.

Referring to FIG. 5c, the pattern 25 is achieved by etching of the optical substrate to a depth at least equal to the depth of implantation. Any of the known etching methods is suitable, provided that it leads to acceptable geometrical characteristics, especially the profile and the surface condition of the sides.

It can be noticed here that the first method presents the advantage of defining a guide layer of which the structure is perfectly plane as it does not comprise the etching step.

Referring to FIG. 5d, the mask is withdrawn and the substrate is here also annealed. The guide layer 33 and eventually the covering layer 34 are then deposited in accordance to the first method.

According to an alternative of this second method, a first step consists in implanting the totality of the optical substrate 31 to a dose (D2−D1). The following step consists in implementing a mask defining the second channel C2, then in etching the substrate to de-limit this second channel. The substrate is then implanted to the dose D1, and the next step consists in implementing the mask which defines a pattern complementary to that of the first mask used during the first method. The substrate is then etched, and the guide layer is deposited.

A third method makes use of the ion exchange technology. In this case, the substrate is a glass containing moving ions at relatively low temperature, a glass of silicate containing for example sodium oxide. The substrate is as well provided with a mask and, with respect to the first method, the implantation step is replaced by a dipping step in a bath containing polarizable ions, such as silver or potassium ions. The pattern is thus implemented by increase of the refractive index consecutive to the exchange of the polarizable ions with the moving ions of the substrate. Then, generally, the channel is buried by application of an electric field perpendicular to the face of the substrate.

This third method shows great simplicity. However, it imposes a selection of a particular substrate which doesn't necessarily have all the desired characteristics. Moreover, due to an important lateral diffusion of the ions, the spatial resolution is limited.

A fourth method makes use of the thin layer technology. Generally, the upper face of the substrate is in silicon dioxide. A first layer 61 of index higher than that of the silicon dioxide is deposited on the optical substrate by means of any known method such as the flame hydrolysis deposition (“Dépôt par hydrolyse à la flamme” in French terminology), high or low pressure chemical vapour deposition and assisted or not by plasma, vacuum deposition, sputtering or spinning deposition. This layer is often in doped silicon dioxide, silicon oxynitride, silicon nitride, and we can also use polymers or sol-gels. A mask defining the first channel C1 including the coupling section S is then applied to the deposited layer 61. Then, this channel is implemented by a chemical etching or by a dry etching process, such as plasma etching, reactive ion etching or ion-beam etching.

The mask is withdrawn after the etching, and a second layer 62 is deposited. Another mask defining the second channel C2 is then applied on the second layer 62 before a new etching step. The guide layer 33 is then deposited on the two channels.

We are here confronted with the difficulty to stack two masks with great accuracy.

According to an alternative, to prevent the step which occurs at the overlap of the two channels, the mask used to etch a first layer 61 defines the first channel C1 without the coupling section S.

This method requires an etching operation which is hard to master so much on the spatial resolution field than on the surface condition of the channel sides, characteristics that directly condition the losses to the propagation of the adapter.

The embodiment examples of the invention shown above have been chosen for their concrete nature. However, it wouldn't be possible to list exhaustively all the embodiments of the invention. In particular, any step or any mean described can be replaced by an equivalent step or mean without coming out of the scope of the invention.

1. Optical mode adapter, comprising first (C1) and second (C2) channels on an optical substrate (31) designed for connection of first and second waveguides respectively to its first (11) and second (12) ends,
characterised is that said two channels being covered with at least one guide layer (33), the refractive index of the first channel (C1) is lower than that of the second channel (C2).

2. Adapter according to claim 1, characterized in that the width of the first channel (C1) is higher than that of the second channel (C2).

3. Adapter according to claim 1, characterised in that it comprises an adaptation cell (2) in which the two channels (C1, C2) are in contact, the first (21) and second (22) ends of this cell, respectively, being disposed near the first (11) and second (12) ends of the adapter, respectively, the width of the first channel (CI) decreasing from the first end (21) to the second end (22) of said adaptation cell.

4. Adapter according to claim 3, characterised in that the width of the first channel (C1) is zero at the second end (22) of said adaptation cell.

5. Adapter according to claim 1, characterised in that it comprises an adaptation call 2 in which the two channels (C1, C2) are in contact, the first (21) and second (22) ends of this cell, respectively, being disposed near the first (11) and second (12) ends of the adapter, respectively, the width of the second channel (C2) decreasing from the second end (22) to the first end (21) of said adaptation cell.

6. Adapter according to claim 5, characterised in that the width of the second channel (C2) is zero at the first end (21) of said adaptation cell.

7. Adapter according to claim 3 characterised in that the second end (22) of said adaptation cell coincides with the second end (12) of said adapter.

8. Adapter according to claim 1, characterised in that the index of this guide layer (33) is higher than that of the substrate (31).

9. Adapter according to claim 3, characterised in that it comprises at least one covering layer (34) disposed on said guide layer (33), the index of this covering layer being lower than that of the guide layer and that of said channels (C1, C2),

10. Adapter according to claim 3, characterised in that at least one of said channels (C1, C2) is integrated in said substrate (31).

11. Adapter according to claim 3, characterised in that at least one of said channels (C1, C2) projects on said substrate (31).

12. Adapter according to claim 1, characterised in that the index of said guide layer (33) is equivalent to that of the substrate (31) multiplied by a factor higher than 1.001.

13. Adapter according to claim 1, characterised in that the thickness of the whole of the guide layers (33) is between 1 and 20 microns.

14. Adapter according to claim 3, characterised in that at least one said channels (C1, C2) results from an ion implantation in said substrate (31).

15. Method for marking an adapter according to claim 1, characterised in that it includes the following steps:
implementation of a mask on said substrate (31) to define the M-shaped pattern of at least one of said channels (C1, C2),
ion implantation, of the masked substrate,
withdrawal of said mask,
deposition of said guide layer (33) on the substrate.

16. Method for making an adapter according to claim 1, characterised in that it includes the following steps:
ion implantation of the substrate (31),
implementation of a mask on said substrate to define the M-shaped pattern of at least one of said channels (C1, C2),
etching of the substrate (31) in a depth at least equal to the depth of implantation,
withdrawal of said mask,
deposition of said guide layer (33) on the substrate.

17. Method according to claim 15, charectarised in that it includes a step of annealing of the substrate (31) which follows the ion implantation step.

18. Method for making an adapter according to claim 1, characterised in that it includes the following steps:
implementation of a mask on said substrate (31) comprising moving ions to define the M-shaped pattern of at least one of said channels (C1, C2),
dipping of the masked substrate in a bath comprising polarizable ions,
withdrawal of said mask,
deposition of said guide layer (33) on the substrate.

19. Method for making an adapter according to claim 1, characterised in that it includes the following steps:
deposition of a first layer (61) of higher refractive index than that of said substrate (31),
implementation of a first mask on this substrate (31) to define the said first channel (C1),
etching of the substrate (31),
withdrawal of said first mask,
deposition of a second layer (62),
implementation of a second mask on this substrate (31) to define the said second channel (C2),
etching of the substrate (31),
withdrawal of said second mask,
deposition of said guide layer (33) on the substrate.
